(19) United States
(12) Patent Application Publication
(10) Pub. No.: US 2016/0377713 A1
(43) Pub. Date: Dec. 29, 2016

(54) METHOD FOR ESTIMATING REFLECTED WAVE ARRIVAL DIRECTION, AND PROGRAM

(71) Applicant: NIDEC ELESYS CORPORATION, Kawasaki-shi-Kanagawa (JP)

(72) Inventors: Hiroyuki KAMO, Kawasaki-shi (JP); Yoshihiko KUWAHARA, Hamamatsu-shi (JP)

(73) Assignee: National University Corporation Shizuoka University, Shizuoka-shi, Shizuoka (JP)

(21) Appl. No.: 15/102,982

(22) PCT Filed: Dec. 12, 2014
(86) PCT No.: PCT/JP2014/083058

§ 371 Date: Jun. 9, 2016

(30) Foreign Application Priority Data
Dec. 12, 2013 (JP) 2013-257485

(51) Int. Cl. G01S 13/536; G01S 7/41

(52) U.S. Cl. CPC G01S 13/536; G01S 7/411; G01S 2013/0254

(57) ABSTRACT

A method of estimating a reflected wave arrival direction using a radar apparatus includes obtaining a first, reflected signal by performing transmission and/or reception of radio waves using a first directional distribution pattern of sensitivity, obtaining a number of first targets by estimating a number of targets in a reflected wave based on the first reflected signal, obtaining a second reflected signal by performing transmission and/or reception of radio waves using a second directional distribution pattern of sensitivity, obtaining a number of second targets by estimating a number of targets in the reflected wave based on the second reflected signal, obtaining a third reflected signal by performing transmission and/or reception of radio waves using a third directional distribution pattern of sensitivity, obtaining a number of third targets by estimating a number of targets in the reflected wave based on the third reflected signal, and estimating the number of targets and the direction of presence of the targets using the numbers of the first, second and third targets and the first, second and third directional distribution patterns of sensitivity.

### BACKGROUND OF THE INVENTION

Field of the Invention

The present invention relates to a method of estimating a reflected wave arrival direction in a radar.

Description of the Related Art

In recent years, radar apparatuses for measuring a distance to a target and the relative velocity and direction of the target using a radar, such as a millimeter-wave radar, to detect the target based on waves reflected from the target (also referred to as a reflective object or a physical object) have been put into practical use. For example, radar apparatuses using such radar types as an FMCW (Frequency Modulated Continuous Wave) radar, a multi-frequency CW (Continuous Wave) radar and a pulse radar, are known as automotive radars.

An array antenna-type electronic scanning radar apparatus (also referred to as an element space-type radar apparatus) and an independent multi-beam radar apparatus (also referred to as a beam space-type radar apparatus) are known as such radar apparatuses.

In recent years, a radar apparatus using a dielectric-lens antenna has been developed (see, for example, Japanese Patent Laid-Open No. 2009-156582) also in the field of vehicle-mounted independent multi-beam radar apparatuses for which a dielectric-lens antenna is under study for an independent multibeam system (see, for example, “Kaitei Radar Gijutsu (in Japanese) (Radar Technology—Revised Version) supervised by Takashi Yoshida, the Institute of Electronics, Information and Communication Engineers, “Corona Publishing Co., Ltd. (1996)).

In such an automotive radar, an AR spectral estimation method (including a maximum entropy method and a linear prediction method) in which a high resolution can be obtained with a smaller number of channels, and a spectral estimation method using a high-resolution algorithm, such as a MUSIC (MUltiple SIgnal Classification) method, have been used in recent years as a signal processing technique for detecting the direction of an incoming wave (received wave) from the target (see, for example, Japanese Patent Laid-Open Nos. 2012-168156 and 2012-168157 and “Kaitei Radar Gijutsu (in Japanese) (Radar Technology—Revised Version), “Adaputibu Antena Gijutsu (in Japanese) (Adaptive Antenna Technology)” written by Nobuyoshi Kikuma, Ohmsha, Ltd. (2003), and “Koubunkainou Touraiha Suiteihou no Kiso to Jissai (in Japanese) (Basics and Actuals of High-resolution Arrival Wave Estimation Method)” written by Hiroyoshi Yamada, Technical Committee on Antennas and Propagation, The Institute of Electronics, Information and Communication Engineers (2006)). By adopting such a signal processing technique for detecting a reflected wave arrival direction and simultaneously realizing a high gain and wide-angle scanning, it is possible to reliably detect targets small in reflective cross-sectional area, such as two-wheel vehicles and persons.

As described above, a variety of methods have been proposed as methods of detecting a target in the conventional radar technology for forming a plurality of beams. In such a conventional radar technology for forming a plurality of beams, however, a high computational load is applied in some cases to detect the target.

### SUMMARY OF THE INVENTION

In view of such circumstances as described above, preferred embodiments of the present invention provide a radar apparatus, a radar method, and a control program capable of reducing a computational load applied to detect a target.

A method of estimating a reflected wave arrival direction according to one aspect of various preferred embodiments of the present invention using a radar apparatus including an antenna capable of selecting and transmitting or receiving one of three or more directional distribution patterns of sensitivity includes: obtaining a first reflected signal by performing one or both of the transmission and reception of radio waves using a first pattern which is one of the three or more directional distribution patterns of sensitivity; obtaining the number of first targets by estimating the number of targets in the reflected wave based on the first reflected signal; obtaining a second reflected signal by performing one or both of the transmission and reception of radio waves using a second pattern which is one of the three or more directional distribution patterns of sensitivity; obtaining the number of second targets by estimating the number of targets in the reflected wave based on the second reflected signal; obtaining a third reflected signal by performing one or both of the transmission and reception of radio waves using a third pattern which is one of the three or more directional distribution patterns of sensitivity; obtaining the number of third targets by estimating the number of targets in the reflected wave based on the third reflected signal; and estimating the number of targets and the direction of presence of the targets using the number of the first targets, the number of the second targets, the number of the third targets, the first directional distribution pattern of sensitivity, the second directional distribution pattern of sensitivity, and the third directional distribution pattern of sensitivity.

One aspect of various preferred embodiments of the present invention may be a method including: selecting one directional distribution pattern of sensitivity in which the antenna has sensitivity to the estimated direction of presence of the targets from the three or more directional distribution patterns of sensitivity; selecting the reflected signal obtained in the selected pattern as a reflected wave arrival direction estimation signal if the selected pattern is one of the first to third patterns; obtaining a reflected wave arrival direction estimation signal by performing one or both of the transmission and reception of radio waves using the selected pattern if the selected pattern is none of the first to third patterns; and making a calculation to estimate a reflected wave arrival direction using the estimated number of targets and the reflected wave arrival direction estimation signal for a direction in which the antenna has sensitivity in the selected pattern.

One aspect of various preferred embodiments of the present invention may be a method in which the antenna has sensitivity in the second pattern in part of a direction in which the antenna does not have sensitivity in the first pattern, the antenna has sensitivity in the third pattern in part of a direction in which the antenna does not have sensitivity in the second pattern, and the antenna has sensitivity in the first pattern in part of a direction in which the antenna does not have sensitivity in the third pattern.

One aspect of various preferred embodiments of the present invention may be a method in which the antenna includes three or more antenna elements, and two or more antenna elements of the three or more antenna elements but less than the total number of the antenna elements are driven in one or more than one of the first to third patterns.

One aspect of various preferred embodiments of the present invention may be a method in which the antenna includes three or more antenna elements, two or more antenna elements of the three or more antenna elements but less than the total number of the antenna elements are driven in at least two patterns of the first to third patterns, and the combination of the antenna elements to be driven differs between the two patterns.

One aspect of various preferred embodiments of the present invention may be a method in which the antenna includes three or more antenna elements, two or more antenna elements of the three or more antenna elements but less than the total number of the antenna elements are driven in at least two patterns of the first to third patterns, at least one of the antenna elements to be driven in the two patterns includes a phase shifter for generating a phase difference between radio waves to be transmitted or received, the phase difference generated by the phase shifter is variable, and the value of the phase difference generated by the phase shifter differs between the two patterns.

One aspect of various preferred embodiments of the present invention may be a method in which the antenna includes three or more antenna elements, and at least two of the three or more antenna elements have different sensitive directions.

One aspect of various preferred embodiments of the present invention may be a method in which the antenna includes a dielectric lens.

One aspect of various preferred embodiments of the present invention may be a method in which the antenna is a phased-array antenna including three or more antenna elements, at least two of the three or more antenna elements each include a phase shifter for generating a phase difference between radio waves to be transmitted, beam forming is performed in at least two patterns of the first to third patterns by generating a phase difference between radio waves using the phase shifters, and the at least two patterns have beam shapes extending from the antenna in directions different from each other.

One aspect of various preferred embodiments of the present invention may be a method in which digital beam forming for extracting components in a direction in which the beam extends in the patterns in which the respective reflected signals are obtained is performed on at least two reflected signals, among the first to third reflected signals, obtained by transmission and reception in the at least two patterns.

One aspect of various preferred embodiments of the present invention may be a method in which two or more of the three or more antenna elements are driven in all of the first to third patterns and a correlation matrix and an eigenvalue of the correlation matrix are calculated for each of the first to third reflected signals when the numbers of the first to third targets are obtained.

A control program according to one aspect of various preferred embodiments of the present invention and stored in a non-volatile storage medium and instructing execution by a computer is a control program that is stored not in a temporary manner but in a computer-readable storage medium, the control program being stored in a non-volatile storage medium and causing a computer to execute the estimation of a reflected wave arrival direction using a radar apparatus including an antenna capable of selecting and transmitting or receiving one of three or more directional distribution patterns of sensitivity, and includes: obtaining a first reflected signal by performing one or both of the transmission and reception of radio waves using a first pattern which is one of the three or more directional distribution patterns of sensitivity; obtaining the number of first targets by estimating the number of targets in the reflected wave based on the first reflected signal; obtaining a second reflected signal by performing one or both of the transmission and reception of radio waves using a second pattern which is one of the three or more directional distribution patterns of sensitivity; obtaining the number of second targets by estimating the number of targets in the reflected wave based on the second reflected signal; obtaining a third reflected signal by performing one or both of the transmission and reception of radio waves using a third pattern which is one of the three or more directional distribution patterns of sensitivity; obtaining the number of third targets by estimating the number of targets in the reflected wave based on the third reflected signal; and estimating the number of targets and the direction of presence of the targets using the number of the first targets, the number of the second targets, the number of the third targets, the first directional distribution pattern of sensitivity, the second directional distribution pattern of sensitivity, and the third directional distribution pattern of sensitivity.

According to various preferred embodiments of the present invention, it is possible to provide a radar apparatus, a radar method, and a control program capable of selecting a suitable detection method according to the situation of targets.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a block diagram illustrating the configuration of an independent multi-beam radar apparatus according to a preferred embodiment of the present invention.

FIG. 2 is a block diagram illustrating a first configuration example of an FMCW-type signal processor.

FIGS. 3A and 3B are graphs showing one example of the relationship between a transmitted signal and a received signal.

FIGS. 4A and 4B are graphs showing a beat frequency and the peak values thereof.

FIG. 5 is a block diagram illustrating a second configuration example of the FMCW-type signal processor.

FIG. 6 is a graph showing one example of the directional characteristics of multibeams.

FIG. 7 is a schematic view illustrating a flow of processing performed in a direction detector.

FIG. 8 is a schematic flowchart illustrating a first variation of the flow of processing performed in the direction detector.

FIG. 9 is a schematic flowchart illustrating a second variation of the flow of processing performed in the direction detector.

FIG. 10 is a schematic flowchart illustrating a flow of processing performed in a signal processor.

FIG. 11 is a schematic view illustrating the relationship between independent multibeams and lower-order classes.

FIG. 12 is a table showing one example of compatibility conditions in a case where the number of incoming waves in a present preferred embodiment of the present invention is three.

FIG. 13 is a table showing one example of compatibility conditions in a case where the number of incoming waves in a present preferred embodiment of the present invention is two.

FIG. 14 is a table showing one example of compatibility conditions in a case where the number of incoming waves in a present preferred embodiment of the present invention is one.

FIG. 15 is a block diagram illustrating the configuration of a variation of a present preferred embodiment of the present invention.

### DETAILED DESCRIPTION OF THE PREFERRED EMBODIMENTS

### Explanation of Terms and Phrases

Terms and phrases will be explained prior to describing preferred embodiments of the present invention.

In the present application, an antenna system for forming a plurality of independent beams is referred to as an “independent multibeam antenna system.” Note that a beam refers to a region which spreads before each antenna element and in which the antenna element has sensitivity to an incident radio wave, or a region across which a radiated radio wave spreads.

An “independent multibeam antenna” is an antenna which forms a plurality of independent beams different in direction from each other or one another. A typical example of the independent multibeam antenna is provided with a lens or a reflecting mirror having a plurality of focal points, and a plurality of antenna elements (a plurality of beam elements or a plurality of feed elements) respectively placed in the plurality of focal points.

Another example of the independent multibeam antenna is provided with a plurality of partial array antennas. By changing the radiation direction of a beam for each partial array antenna, it is possible to simultaneously radiate a plurality of beams in different directions, or successively radiate one or more than one beam in different directions in a “sufficiently short period of time” substantially equivalent to “simultaneously”. Each partial array antenna includes several antenna elements disposed in arrays and radiates beams oriented in specific directions using these several antenna elements. Each antenna element may be a constituent part of one of the partial array antennas or a constituent part of two or more partial array antennas. Each “partial array antenna” corresponds to the abovementioned “beam element” or “feed element.”

In the case of the independent multibeam antenna, the received signal of each of the plurality of beam elements differs depending on the direction of a beam. More specifically, the received signal of a certain beam is independent of the received signal of another beam, and therefore, there is no substantial correlation between these received signals. Note that in the case of the above-described partial array antenna, however, there can be a correlation between or among antenna elements constituting each partial array antenna.

An array antenna including three or more antenna elements in which beams to be formed are superimposed is referred to as a phased-array antenna in the present invention. The phased-array antenna is a concept opposed to the independent multibeam antenna. However, it is possible to configure an antenna which includes a plurality of phased-array antennas and in which a signal correlation between or among the plurality of phased-array antennas is low. Such an antenna corresponds to an independent multibeam antenna in which an antenna for forming each beam is a partial array antenna, and the partial array antenna is a phased-array antenna.

### First Preferred Embodiment

Hereinafter, a first preferred embodiment of the present invention will be described with reference to the accompanying drawings.

### Configuration Example of Independent Multi-Beam Radar Apparatus

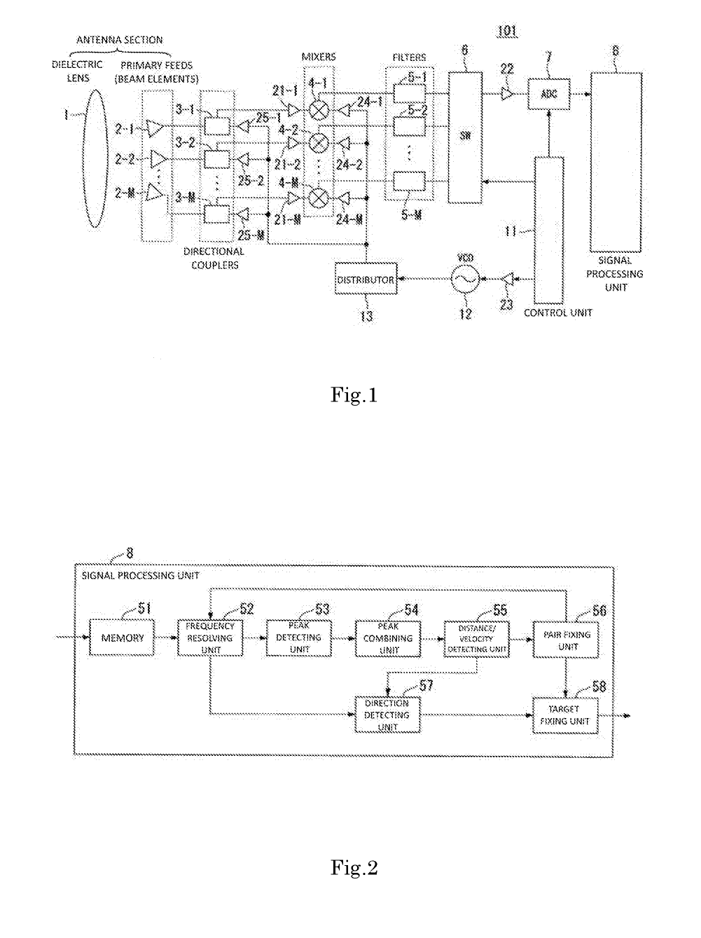

FIG. 1 is a block diagram illustrating the configuration of an independent multi-beam radar apparatus 101 according to a preferred embodiment of the present invention. The present preferred embodiment represents a case where the present invention is applied to an automotive millimeter wave radar of an independent multibeam type with a dielectric-lens antenna.

As illustrated in FIG. 1, the independent multi-beam radar apparatus 101 according to the present preferred embodiment is provided with a dielectric lens 1; the M number of beam elements (antenna elements) 2-1 to 2-M which are a plurality of primary feeds; the M number of directional couplers 3-1 to 3-M; the M number of mixers 4-1 to 4-M; the M number of filters 5-1 to 5-M; an SW (switch) 6; an ADC (A/D (analog-to-digital) converter) 7; a signal processor 8; a control unit 11; a VCO (voltage-controlled oscillator) 12; and a distributor 13. Here, M denotes the number of the beam elements 2-1 to 2-M.

The independent multi-beam radar apparatus 101 according to the present preferred embodiment is also provided with the M number of amplifiers 21-1 to 21-M between the M number of directional couplers 3-1 to 3-M and the M number of mixers 4-1 to 4-M; an amplifier 22 between the SW 6 and the ADC 7; an amplifier 23 between the control unit 11 and the VCO 12; the M number of amplifiers 24-1 to 24-M between the distributor 13 and the M number of mixers 4-1 to 4-M; and the M number of amplifiers 25-1 to 25-M between the distributor 13 and the M number of directional couplers 3-1 to 3-M.

Here in the present preferred embodiment, the dielectric lens 1 and the plurality of beam elements 2-1 to 2-M constitute an antenna section. In addition, multibeams which can be transmitted and received simultaneously are formed by the directional couplers 3-1 to 3-M connected respectively to the beam elements 2-1 to 2-M.

### <First Configuration Example of Signal Processor>

FIG. 2 is a block diagram illustrating a first configuration example of an FMCW-type signal processor (hereinafter described as the signal processor 8). As illustrated in FIG. 2, the signal processor 8 according to the first configuration example of the present preferred embodiment is provided with a memory 51; a frequency resolving unit 52; a peak detector 53; a peak combining unit 54; a distance/velocity detector 55; a pair fixing unit 56; a direction detector 57; and a target fixing unit 58.

Operation Example of Independent Multi-Beam Radar Apparatus 101 Provided with Signal processor 8 According to First Configuration Example

An example of operation performed in the independent multi-beam radar apparatus 101 according to the present preferred embodiment will be described by referring again to FIG. 1. The control unit 11, which adopts an FMCW method, outputs a signal to the VCO 12 through the amplifier 23.

Based on the signal input from the control unit 11, the VCO 12 outputs a frequency-modulated CW signal (FMCW signal) to the distributor 13. The distributor 13 splits the FMCW signal input from the VCO 12 into two signals, outputs one of the split signals to the respective directional couplers 3-1 to 3-M through the respective amplifiers 25-1 to 25-M, and outputs the other split signal to the respective mixers 4-1 to 4-M through the respective amplifiers 24-1 to 24-M.

The FMCW signal sent from the distributor 13 to the respective directional couplers 3-1 to 3-M is sent to the respective beam elements 2-1 to 2-M through the respective directional couplers 3-1 to 3-M and is (wirelessly) transmitted from the respective beam elements 2-1 to 2-M through the dielectric lens 1.

This transmitted wave, if reflected by a target, returns as a reflected wave. In this case, this reflected wave is received by the respective beam elements 2-1 to 2-M through the dielectric lens 1 and input to the respective directional couplers 3-1 to 3-M. This received wave (the reflected wave received) is input from the respective directional couplers 3-1 to 3-M to the respective mixers 4-1 to 4-M through the respective amplifiers 21-1 to 21-M.

Each of the mixers 4-1 to 4-M mixes a received wave (received signal) input from each of the directional couplers 3-1 to 3-M and an FMCW signal (transmitted signal) input from the distributor 13, and outputs a beat signal which is a signal resulting from the mixing to the respective filters 5-1 to 5-M. Here, beat signals corresponding to the number of elements (M) are generated.

The respective filters 5-1 to 5-M filter (band-limit) beat signals input from the mixers 4-1 to 4-M, and outputs the band-limited beat signals to the SW 6. Here, the beat signals input from the respective mixers 4-1 to 4-M to the respective filters 5-1 to 5-M correspond to beat signals of channels (CH) 1 to M corresponding to the respective beam elements 2-1 to 2-M generated in the respective mixers 4-1 to 4-M.

The SW 6 is controlled by the control unit 11 to perform switching operation and output beat signals input from the M number of filters 5-1 to 5-M to the ADC 7 through the amplifier 22. Specifically, the SW 6 successively switches over the beat signals of the CHs 1 to M corresponding to the respective beam elements 2-1 to 2-M having passed through the respective filters 5-1 to 5-M, according to sampling signals input from the control unit 11, and outputs the beat signals to the ADC 7 through the amplifier 22.

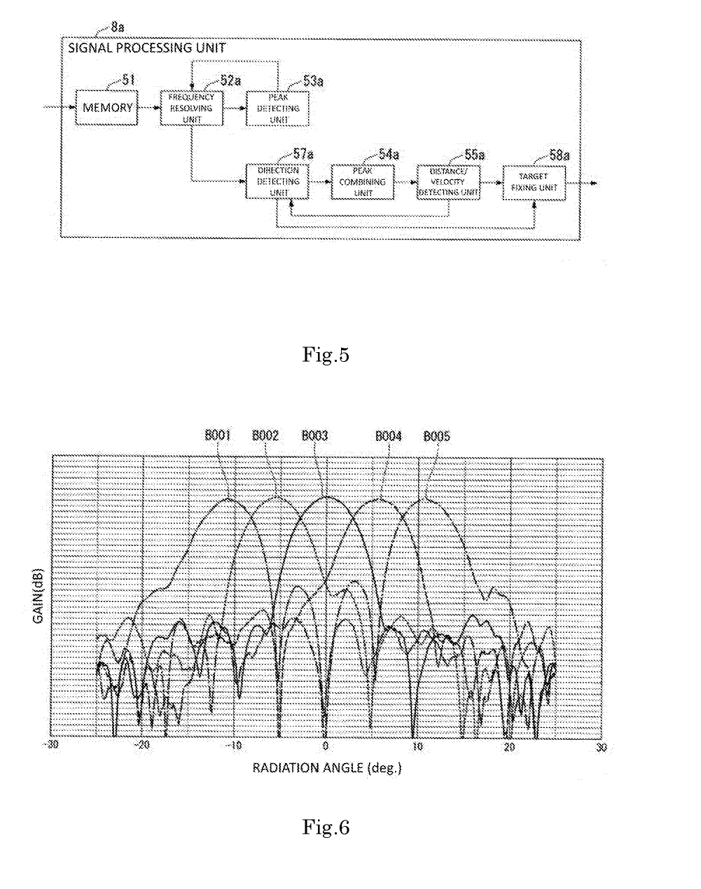

The ADC 7 is controlled by the control unit 11 to A/D-convert the beat signals input from the SW 6 and output the A/D-converted beat signals to the signal processor 8. Specifically, the ADC 7 A/D-converts, in synchronization with the sampling signals, the beat signals of the CHs 1 to M corresponding to the respective beam elements 2-1 to 2-M input from the SW 6 in synchronization with the sampling signals, from analog signals to digital signals. Then, the ADC 7 successively stores these digital signals in a waveform storage area of the memory of the signal processor 8 (the memory 51 shown in FIG. 2 or 5 in the present preferred embodiment). Consequently, received data (data on the beat signals) is sent to the signal processor 8 for each of the beam elements 2-1 to 2-M (for the CH of each element).

The control unit 11 controls the switching operation of the SW 6. The control unit 11 also controls the ADC 7. Specifically, the control unit 11 outputs sampling signals to the SW 6 and the ADC 7. Here, the control unit 11 includes, for example, a microcomputer and controls the independent multi-beam radar apparatus 101 as a whole illustrated in FIG. 1 based on a control program stored in an unillustrated non-volatile storage medium, such as an ROM (Read Only Memory). Note that in the present preferred embodiment, the dielectric lens 1, the beam elements 2-1 to 2-M, the directional couplers 3-1 to 3-M, the amplifiers 21-1 to 21-M, the mixers 4-1 to 4-M, the filters 5-1 to 5-M, the SW 6, the amplifier 22, and the ADC 7 constitute a receiving section. The receiving section may be configured using a reflecting mirror for reflecting signal waves in place of the dielectric lens 1. In addition, in the present preferred embodiment, the VCO 12 and the distributor 13 constitute a beat signal generating section.

Next, an example of operation performed in the FMCW-type signal processor 8 according to the first configuration example of the present preferred embodiment illustrated in FIG. 2 will be described. According to data from the ADC 7, the memory 51 stores time-series data (ascending and descending regions), into which received signals (beat signals) have been A/D-converted, in the waveform storage area in correspondence with each of the beam elements 2-1 to 2-M. For example, if 256 data items are sampled in each of the ascending and descending regions, data items corresponding to 2 X 256 X the number of elements are stored in the waveform storage area. In this manner, the CH-by-CH beat signal of each of the beam elements 2-1 to 2-M is stored in the memory 51.

The frequency resolving unit 52 transforms each of beat signals corresponding to the respective CHs 1 to CHM (respective beam elements 2-1 to 2-M) into frequency components by, for example, a Fourier transform, according to a preset resolution, thereby outputting frequency points indicating beat frequencies and complex data on the beat frequencies. For example, if each of the ascending and descending regions has 256 sampled data items for each of the beam elements 2-1 to 2-M, the data items are transformed into the beat frequency as complex frequency domain data for each of the beam elements 2-1 to 2-M, thus resulting in 128 complex data items (data items corresponding to 2×128×the number of elements) of the ascending and descending regions. In addition, the beat frequencies appear at the frequency points.

As described above, the frequency resolving unit 52 transforms beat signals into a range of beat frequencies by means of, for example, Fourier transform for each CH of the respective beam elements 2-1 to 2-M.

For peak values of the intensity in the ascending and descending regions of a triangular wave at the frequency-transformed beat frequencies, the peak detector 53 detects a beat frequency having a peak value exceeding a preset numerical value (peak detection threshold) from peaks in signal intensity (or amplitude, for example) using complex data, thereby detecting the presence of a target for each beat frequency and selecting a target frequency.

As described above, the peak detector 53 converts each complex data item of the beam elements 2-1 to 2-M into a frequency spectrum and thus can detect each peak value of the respective spectrums as the beat frequency, i.e., the presence of a target depending on the distance.

The peak combining unit 54 combines the beat frequencies of the ascending and descending regions and the peak values thereof in a matrix-like, round-robin manner with respect to the beat frequencies and the peak values output by the peak detector 53 for each beam element, thereby combining all the beat frequencies of the ascending and descending regions and successively outputting the combined frequencies to the distance/velocity detector 55.

Note that in the present preferred embodiment, such combination is performed for each CH of the beam elements 2-1 to 2-M, and therefore, it is possible to detect the presence of a target in each beam direction.

The distance/velocity detector 55 calculates a distance r to the target according to a numerical value given by adding successively-input combinations of beat frequencies of the ascending and descending regions. In addition, the distance/velocity detector 55 calculates a velocity v relative to the target according to differences among the successively-input combinations of beat frequencies of the ascending and descending regions.

Note that in the present preferred embodiment, such calculations of the distance r and the relative velocity v are made for each CH of the beam elements 2-1 to 2-M.

For each CH, the pair fixing unit 56 creates a first pair table according to the distance r and the relative velocity v thus input and peak value levels pᵤ and p_{d} of the ascending and descending regions, determines a suitable combination of peaks of each of the ascending and descending regions for each target, fixes pairs of peaks of each of the ascending and descending regions using a second pair table, and outputs a target group number representing the fixed distance r and relative velocity v to the target fixing unit 58.

The first pair table shows a matrix of beat frequencies of the ascending and descending regions in the peak combining unit 54, and distances and relative velocities at intersecting points of the matrix, i.e., combinations of beat frequencies of the ascending and descending regions.

The second pair table shows distances, relative velocities and frequency points for each target group. For example, distances, relative velocities and frequency points (in the ascending region and/or the descending region) are stored in the second pair table in correspondence with each target group number. Note that the first and the second pair tables are stored in, for example, the internal storage unit of the pair fixing unit 56.

The pair fixing unit 56 may alternatively employ a method of, for example, selecting combinations in a target group by giving priority to a value predicted in the current detection cycle from each distance r to a target and each relative velocity v finally fixed in the previous detection cycle.

In addition, the pair fixing unit 56 notifies the frequency resolving unit 52 of frequencies whose pairs have been fixed on a CH-by-CH basis. In response, the frequency resolving unit 52 outputs specific frequency point data (complex data) on the beam elements 2-1 to 2-M (CHs) used to make a direction prediction (direction detection) to the direction detector 57. That is, if a pair is present at a specific frequency point of a certain CH, the frequency resolving unit 52 outputs the pair together with data on the same frequency points of other CHs as the complex data for direction detection. Here, one or both of the ascending and the descending may be used as this complex data.

The direction detector 57 detects the direction of a target by an adaptive method. Here, the direction detection of a target using an adaptive method will be described. The direction detector 57 performs spectral estimation processing using a MUSIC method, a linear predictive method, or the like which is a high-resolution algorithm. The direction detector 57 detects the direction of a corresponding target based on results of spectral estimation, and outputs the direction to the target fixing unit 58.

At the time of this process in the present preferred embodiment, the direction detector 57 Fourier-transforms complex data (beam element data) on the plurality of beam elements 2-1 to 2-M constituting an antenna into complex data (virtual array data) on a plurality of virtual array elements constituting a virtual array antenna. Then, the direction detector 57 performs spectral estimation processing using a MUSIC method, a linear predictive method, or the like which is a high-resolution algorithm. At this time, the direction detector 57 performs a process of estimating the direction of a target based on a plurality of beams selected from multibeams that the antenna section can transmit. This mechanism of beam selection by the direction detector 57 will be described later. Note that in the present preferred embodiment, the direction detector 57 may detect the direction of a target by a maximum likelihood estimation method which is a high-resolution algorithm based on complex amplitude data on the beam elements 2-1 to 2-M.

The target fixing unit 58 fixes a target based on a distance r, a relative velocity v and a frequency point output by the pair fixing unit 56 and the direction of the target detected by the direction detector 57. As described above, the direction of the target becomes definite along with the distance r and the relative velocity v of the target, and thus the target is fixed. Although this adaptive method may cause an increase in the amount of computation compared with a monopulse method, the method can individually fixes respective targets even if a plurality of targets exist in beams. Specifically, in the antenna configuration of the present preferred embodiment, the adaptive method can individually detect a plurality of targets, whereas the monopulse method cannot individually detect the plurality of targets, in a case where the plurality of targets exist within the range of a single beam lower in resolution than the distance of each target.

Note that the direction detector 57 may detect the direction of a target by the monopulse method. The way the direction of a target is detected by this monopulse method will be described. In direction detection using the monopulse method, two beams, among multibeams, in which antenna patterns overlap partially are paired and used. According to this monopulse method, it is possible to detect a single target present in a pair of beams. The direction detector 57 detects the direction of a target based on a sum signal E and a differential signal A of the reflected waves of these two beams. This detection of the direction of a target using the monopulse method generally needs a smaller amount of computation than detection using the adaptive method. Accordingly, the monopulse method enables higher-speed processing, compared with the adaptive method.

The target fixing unit 58 fixes a target based on the direction of the target detected by the direction detector 57.

### Principles for Detecting Distance, Relative Velocity and Angle (Direction) of Target

Next, an outline of principles used by the signal processor 8 in the present preferred embodiment to detect the distance, relative velocity, and angle (direction) of a target with respect to the independent multi-beam radar apparatus 101 will be described. Here, an FMCW method will be cited as an example.

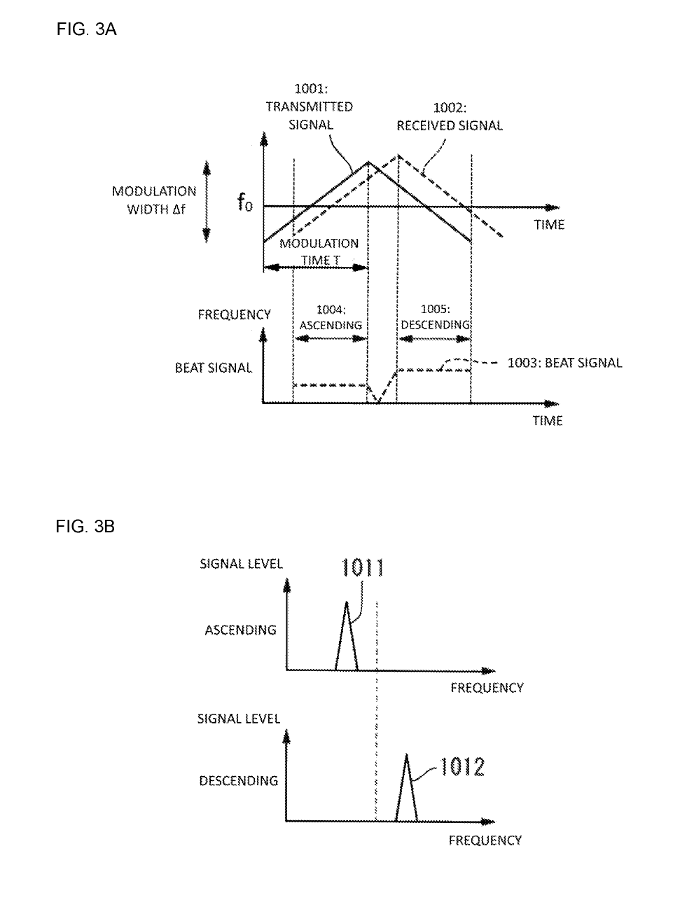

FIGS. 3A and 3B are graphs showing one example of the relationship between a transmitted signal 1001 and a received signal 1002. The example of FIGS. 3A and 3B show a case where the number of targets is one.

FIG. 3A is a graphical view illustrating the relationship between an FMCW signal and a beat signal. Specifically, FIG. 3A illustrates the relationship between the transmitted signal and time, the relationship between the received signal and time, and the relationship between the beat signal and time. In FIG. 3A, the horizontal axis represents the time, whereas the vertical axis represents the frequency.

FIG. 3B is a graphical view illustrating examples of the level of a received signal from a target in the ascending (ascending region) and the descending (descending region). Specifically, FIG. 3B illustrates the relationship between the received signal and the frequency in the ascending and descending regions. In FIG. 3B, the horizontal axis represents the frequency, whereas the vertical axis represents the signal level (intensity).

The signals shown in FIG. 3A are, for example, the transmitted signal 1001 given by frequency-modulating a signal of a triangular wave generated by the control unit 11 in the VCO 12, the signal 1002 received as the result of the transmitted signal 1001 being reflected by a target, and a beat signal 1003 of these signals. Note that FIG. 3A shows an ascending region 1004 and a descending region 1005. In addition, FIG. 3A shows a center frequency f₀, a modulation width Af, and a modulation time T.

As illustrated in FIG. 3A, the received signal 1002 which is a wave reflected from a target is received while being belated rightward (in a time-delay direction) with respect to the transmitted signal 1001 being sent in proportion to a distance to the target. In addition, the received signal 1002 which is a wave reflected from the target varies in a vertical direction (in a frequency direction) with respect to the transmitted signal 1001 in proportion to a velocity relative to the velocity of the target. That is, the beat signal 1003 makes it possible to estimate a distance to the target and a velocity relative to the velocity of the target.

The beat signal 1003 evaluated in FIG. 3A, after being subjected to frequency transformation (Fourier transform, DTC, Hadamard transform, wavelet transform, or the like), has one peak value each in the ascending and descending regions, as shown in FIG. 3B, if the number of targets is one. That is, the number of targets can be estimated by evaluating the peak values of a signal obtained by frequency-transforming the beat signal 1003.

Specifically, an ascending received signal 1011 has a peak value at a frequency fᵤ. In addition, a descending received signal 1012 has a peak value at a frequency f_{d}.

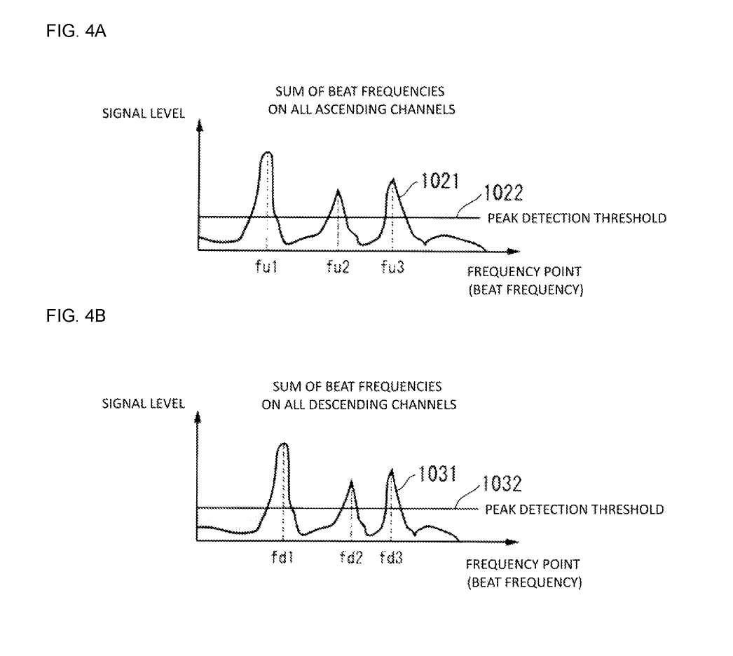

FIGS. 4A and 4B illustrate the results of frequency resolution on the beat signal, and is a set of graphs showing beat frequencies and the peak values thereof. Here, in the graphs of FIGS. 4A and 4B, the horizontal axis represents the frequency point of a beat frequency, whereas the vertical axis represents the level (intensity) of the signal. Specifically, FIG. 4A shows three beat frequencies fᵤ1, fᵤ2 and fᵤ3 having peak values exceeding a preset numerical value (peak detection threshold) 1022 for a beat signal 1021 of a specific beam CH in the ascending region. Likewise, FIG. 4B shows three beat frequencies fd1, fd2 and fd3 having peak values exceeding a preset numerical value (peak detection threshold) 1032 for a beat signal 1031 of a specific beam CH in the descending region. As described above, three targets exist in a distance direction in this example.

Referring back to FIG. 2, the frequency resolving unit 52 performs a frequency resolution on sampled data of the beat signals stored in the memory 51 in each of the ascending region (ascending) and the descending region (descending) of a triangular wave at discrete times and performs a frequency transformation by, for example, Fourier transform. That is, the frequency resolving unit 52 frequency-resolves the beat signals into beat frequencies having a preset frequency bandwidth, and calculates complex data based on the beat signals resolved for each beat frequency.

As a result, a graph of a signal level for each frequency-resolved beat frequency is obtained in each of the ascending and descending regions, as illustrated in FIG. 3B.

The peak detector 53 detects a peak value from a signal level for each beat frequency shown in FIG. 3B, thereby detecting the presence of a target, and outputting beat frequencies (in both the ascending and descending regions) fᵤ and f_{d} having the peak values as target frequencies.

The peak combining unit 54 combines beat frequencies of the ascending and descending regions and the peak values thereof in a matrix-like, round-robin manner with respect to the beat frequencies and the peak values thereof output by the peak detector for each beam element. Thus, the peak combining unit 54 combines all the beat frequencies of the ascending and descending regions and successively outputs the combinations to the distance/velocity detector 55.

The distance/velocity detector 55 calculates the distance r from the target frequency fᵤ of the ascending region and the target frequency f_{d} of the descending region output by the peak combining unit 54 using Expression (1).

Expression 1

r={C×T/(2×Δf)}×{(fᵤ+f_{d})/2} (1)

In addition, the distance/velocity detector 55 calculates the relative velocity v from the target frequency fᵤ of the ascending region and the target frequency f_{d} of the descending region output by the peak combining unit 54 using Expression (2).

Expression 2

v={C/(2×f₀)}×{(fᵤ−f_{d})/2} (2)

The variables in Expression (1) and Expression (2) used to calculate the distance r and the relative velocity v are as follows:

C: Light velocity

Δf: Frequency modulation width of triangular wave

f₀: Center frequency of triangular wave

T: Modulation time (ascending region/descending region)

fᵤ: Target frequency in ascending region

f_{d}: Target frequency in descending region

Second Configuration Example and Operation Example of Signal processor

FIG. 5 is a block diagram illustrating a second configuration example of the FMCW-type signal processor (hereinafter described as the signal processor 8a). As illustrated in FIG. 5, the signal processor 8a according to the second configuration example of the present preferred embodiment is provided with a memory 51; a frequency resolving unit 52a; a peak detector 53a; a direction detector 57a; a peak combining unit 54a; a distance/velocity detector 55a; and a target fixing unit 58a.

Here, the memory 51 is the same as the one shown in FIG. 2 and is, therefore, denoted by the same reference numeral as in FIG. 2. The signal processor 8a illustrated in FIG. 5 is configured to detect directions in both the ascending region (rising region) and descending region (falling region) of a triangular wave in an FMCW method, and then fix pairs.

Like the signal processor illustrated in FIG. 2, the signal processor 8a illustrated in FIG. 5 fixes targets using an adaptive method. The signal processor 8a estimates directions using a high-resolution algorithm to fix targets. Hereinafter, differences in configuration of FIG. 5 from FIG. 2 will be described.

The frequency resolving unit 52a transforms beat signals in the ascending and descending regions into complex data for each antenna and outputs frequency points indicating the beat frequencies of the beat signals and the complex data to the peak detector 53a.

In addition, the frequency resolving unit 52a outputs the complex data corresponding respectively to the ascending and descending regions to the direction detector 57a. This complex data serves as a target group in each of the ascending and descending regions (beat frequencies having peaks in each of the ascending and descending regions).

The peak detector 53a detects peak values of the ascending and descending regions and frequency points where the peak values exist and outputs the frequency points to the frequency resolving unit 52a.

The direction detector 57a performs spectral estimation processing using a MUSIC method, a linear predictive method or the like which is a high-resolution algorithm. The direction detector 57a detects the direction of a corresponding target based on the results of spectral estimation.

At the time of this process in the present preferred embodiment, the direction detector 57a Fourier-transforms complex data (beam element data) on the plurality of beam elements 2-1 to 2-M constituting an antenna into complex data (virtual array data) on a plurality of virtual array elements constituting a virtual array antenna. Then, the direction detector 57a performs spectral estimation processing using a MUSIC method, a linear predictive method, or the like which is a high-resolution algorithm.

The direction detector 57a detects an angle θ for each of the ascending and descending regions and outputs the detected angles to the peak combining unit 54a as direction tables. Here, the direction tables are used to combine peaks of the ascending and descending regions.

As a specific example, a direction table for the ascending region correlates each target group with an angle 1, an angle 2, . . . , and a frequency point f. For example, a target group 1 is correlated with an angle 1 of t1_ang1, an angle 2 of t1_ang2, and a frequency point of f₁. Likewise, a target group 2 is correlated with an angle 1 of t2_ang1, an angle 2 of t2_ang2, and a frequency point of f₂. The same holds true for subsequent target groups.

In addition, a direction table for the descending region correlates each target group with an angle 1, an angle 2, . . . , and a frequency point f. For example, a target group 1 is correlated with an angle 1 of t1_ang1, an angle 2 of t1_ang2, and a frequency point of f₁. Likewise, a target group 2 is correlated with an angle 1 of t2_ang1, an angle 2 of t2_ang2, and a frequency point of f₂. The same holds true for subsequent target groups.

The peak combining unit 54a produces combinations including the same angles using information on a direction table output by the direction detector 57a, and outputs combinations of beat frequencies of the ascending and descending regions to the distance/velocity detector 55a.

The distance/velocity detector 55a calculates distances r to targets using Expression (1) mentioned above, according to successively-input numerical values obtained by summing combinations of beat frequencies of the ascending and descending regions.

In addition, the distance/velocity detector 55a calculates relative velocities v to targets using Expression (2) mentioned above, according to successively-input differences between combinations of beat frequencies of the ascending and descending regions.

Here, the distance/velocity detector 55a calculates the values of distances and relative velocities for combinations of beat frequencies of the ascending and descending regions.

The target fixing unit 58a determines pairs of peaks of the ascending and descending regions to fix targets.

Note that in the foregoing discussion, a procedure has been described by way of example in which the direction of a target is detected based on peak values of the ascending and descending region, and then the peak values of the ascending and descending regions are combined. The present invention is not limited to this procedure, however. For example, peak values of the ascending and descending regions may be combined, and then the direction of a target may be detected based on the combined peak values.

Next, one example of the directional characteristics of multibeams discussed heretofore will be described with reference to FIG. 6.

FIG. 6 is a graph showing one example of the directional characteristics of multibeams. In the graph shown in FIG. 6, the horizontal axis represents the radiation angle, whereas the vertical axis represents the gain. This example of FIG. 6 shows the relationship between the radiation angle and the gain of multibeams composed of five beams, i.e., the directional characteristics of beams. This example of FIG. 6 shows the directional characteristics of beams B001 to B005 serving as multibeams composed of five beams.

### Details on Operation of Direction Detector

Now, details on operation performed in the direction detector 57 illustrated in FIG. 2 will be described. Note that a description to be made here also holds true for operation performed in the direction detector 57a illustrated in FIG. 5.

As principles of various preferred embodiments of the present invention, attention is paid to the Fourier transform-based relationship present between a reception pattern and a distribution of antenna aperture planes (the distribution function of a wave source, for example, a phase distribution function) in a primary feed, in the case of an independent multibeam system.

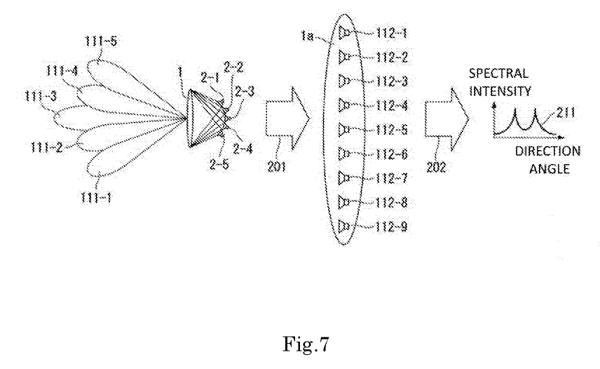

FIG. 7 is a schematic view illustrating a flow of processing performed in the direction detector 57.

Data to be transmitted/received by a plurality of beam elements 2-1 to 2-M (CHs) can be transformed to data to be transmitted/received by a plurality of virtual array elements using Fourier transform.

As one example of a primary feed, FIG. 7 illustrates a case where the number of beam elements 2-1 to 2-M (element number) is five (M=5).

Beams 111-1 to 111-5 are transmitted/received by five beam elements 2-1 to 2-5 with the dielectric lens 1 between the beams and the beam elements.

As one example of virtual array elements, FIG. 7 also illustrates a case where the number of virtual array elements 112-1 to 112-9 (element number) is nine.

In this example, all of the virtual array elements 112-1 to 112-9 are disposed so as to fall within the lens aperture length (the aperture length as that of the dielectric lens 1) of a virtual dielectric lens la the same as the dielectric lens 1.

In addition, a plurality of virtual array elements 112-1 to 112-9 are disposed in this example.

Using data transmitted/received by such virtual array elements 112-1 to 112-M, it is possible to perform processing based on a high-resolution algorithm, such as a MUSIC method or a linear predictive method, or to form a beam with a changed number of elements and element interval.

As a specific example, it is possible to obtain a graph 211 representing the relationship between a direction angle and spectral intensity using a high-resolution algorithm, and make angular measurements of multiple targets at high resolution based on this graph.

Accordingly, from the calculated data on the virtual array elements, it is possible to flexibly set input data in conformity with the convenience of high-resolution algorithmic processing and patterns of beam forming in the direction detector 57 according to the present preferred embodiment, when a direction estimation is made in the execution of a high-resolution algorithm or beam forming.

### Variation 1: Direction Detection by Maximum Likelihood Estimation Method

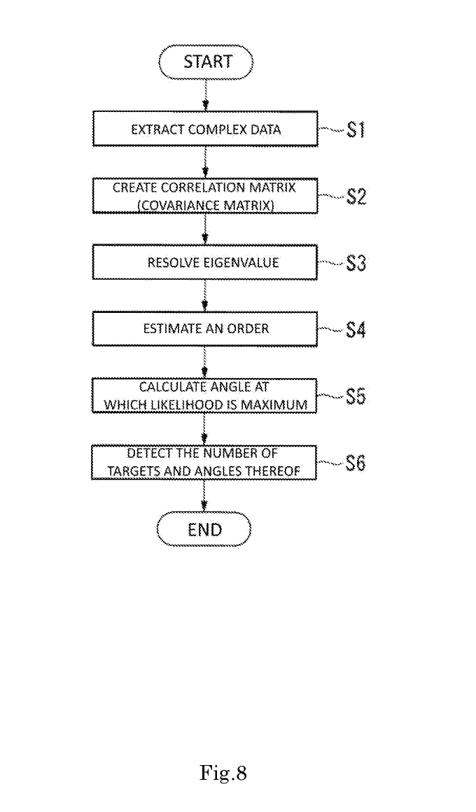

In direction detection, it is also possible to apply such a maximum likelihood estimation method as shown in FIG. 8.

FIG. 8 is a schematic flowchart illustrating a first variation of the flow of processing performed in the direction detector 57. The direction detector 57 generates a steering vector based on a received signal produced by a reflected wave from a target, and calculates the likelihood of a reflected wave arrival direction. Thus, the direction detector 57 calculates an arrival direction in which the likelihood is greatest (highest) as the direction of the target.

In brief, the direction detector 57 reads complex data (step S1).

Next, the direction detector 57 creates a correlation matrix (covariance matrix) (step S2).

Next, the direction detector 57 resolves eigenvalues to calculate eigenvalues λ₁, λ₂, λ₃, . . . and eigenvectors e₁, e₂, e₃, . . . (step S3).

Next, the direction detector 57 estimates an order (step S4).

Next, the direction detector 57 calculates an angle at which likelihood is greatest (maximum likelihood) (step S5).

Then, the direction detector 57 detects the number of targets and the angles thereof (step S6).

As described above, the direction detector 57 can detect the number of targets and the directions (angles) thereof also by a maximum likelihood estimation method.

### Variation 2: Direction Detection by MUSIC Method

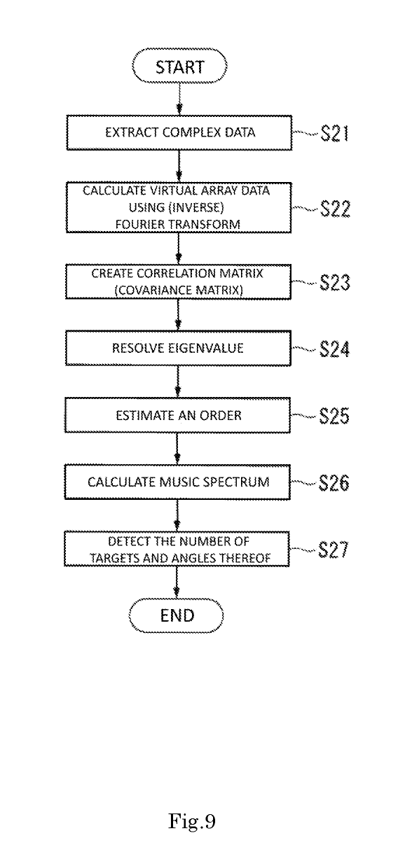

FIG. 9 is a schematic flowchart illustrating a second variation of the flow of processing performed in the direction detector 57. This example shows a case where a MUSIC method which is a high-resolution algorithm is used.

This processing procedure is repeatedly executed for each beat frequency point at which a target whose peaks have been detected exists.

In brief, the direction detector 57 reads complex data (step S21).

Next, the direction detector 57 transforms the complex data using a Fourier transformation formula to calculate virtual array data (step S22).

Next, the direction detector 57 creates a correlation matrix (covariance matrix) (step S23).

Next, the direction detector 57 resolves eigenvalues to calculate eigenvalues λ₁, λ₂, λ₃, . . . and eigenvectors e₁, e₂, e₃, . . . (step S24).

Next, the direction detector 57 estimates an order (step S25).

Next, direction detector 57 calculates a MUSIC spectrum (step S26).

Then, the direction detector 57 detects the number of targets and the angles thereof (step S27).

As described above, the direction detector 57 can detect the number of targets and the directions (angles) thereof also by a MUSIC method.

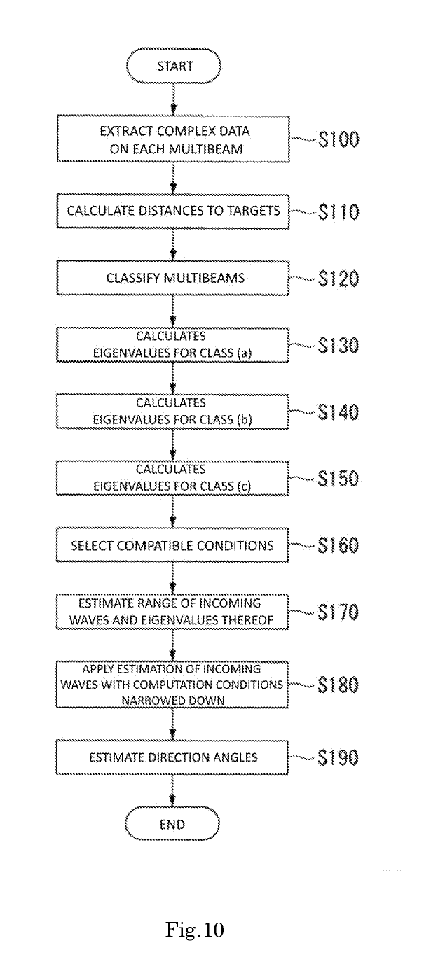

Up to here, a signal processing operation and the variations thereof performed by the signal processor 8 have been described in detail. Next, an operation in which the signal processor 8 classifies multibeams to estimate direction angles will be described with reference to FIGS. 10 to 14. Here, the operation of the signal processor 8 illustrated in FIG. 2 will be described, though the same holds true for the signal processor 8a illustrated in FIG. 5.

FIG. 10 is a schematic flowchart illustrating a flow of processing performed in the direction detector.

The frequency resolving unit 52 extracts (calculates) complex data on each multibeam (step S100). Specifically, the frequency resolving unit 52 performs a frequency resolution on sampled data of the beat signals stored in the memory 51 in each of the ascending region (ascending) and the descending region (descending) of a triangular wave at discrete times and performs a frequency transformation by, for example, the Fourier transformation. Thus, the frequency resolving unit 52 extracts (calculates) complex data based on beat signals frequency-resolved for each beat frequency.

Using Expression (1) mentioned above, the distance/velocity detector 55 calculates the distance r from the target frequency fᵤ of the ascending region and the target frequency f_{d} of the descending region output by the peak combining unit 54 (step S110).

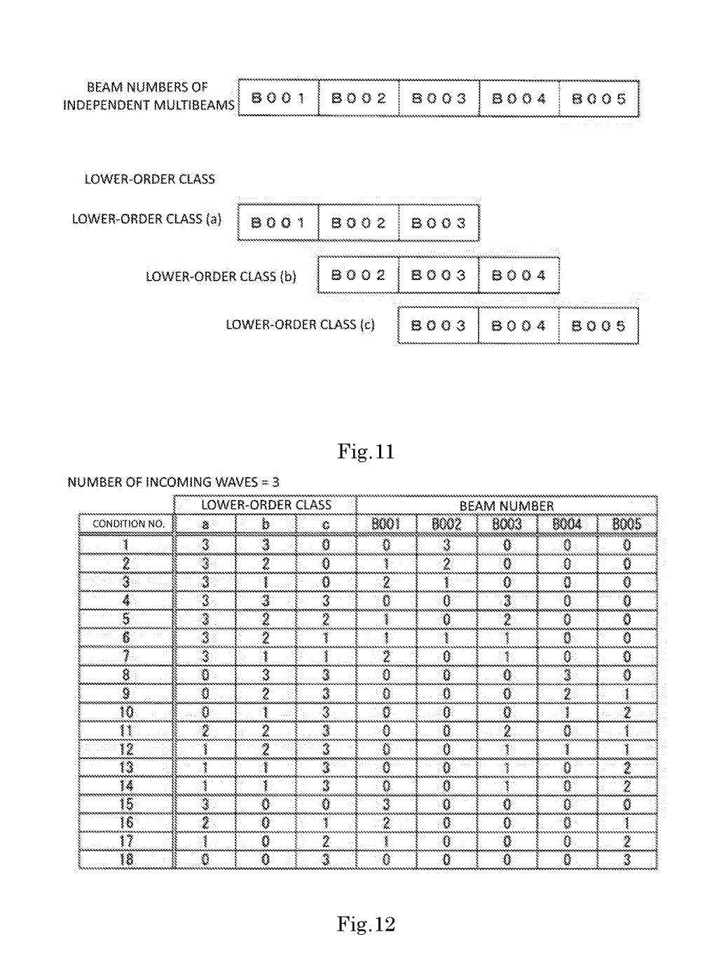

The direction detector 57 classifies the multibeams for the purpose of eigenvalue calculation (step S120). Here, multibeam classification will be described by citing, as an example, a case where the number of beams of an independent multibeam antenna is five and the minimum detectable number of incoming waves from targets is three. Since the minimum detectable number is three in this example, three beams (reflected signals) of independent multibeams are grouped as a set of lower-order class beams to evaluate third-order eigenvalues using a correlation matrix of at least three rows and three columns. An example of this classification of independent multibeams will be described with reference to FIG. 11. Note that a lower-order class in the present preferred embodiment can be rephrased as patterns of directional sensitivity distribution. Each lower-order class (directional distribution patterns of sensitivity) includes directions having sensitivity and directions not having sensitivity. In addition, the three lower-order classes can be respectively rephrased as a first pattern, a second pattern, and a third pattern. In the present preferred embodiment, a plurality of patterns (lower-order classes) are created by changing the selection of beams to be used in an independent multibeam antenna. A method of pattern creation in the present invention is not limited to this method, however. For example, a plurality of directional distribution patterns of sensitivity may be created by beam forming in a phased-array antenna, as will be described later.

FIG. 11 is a schematic view illustrating the relationship between independent multibeams and lower-order classes of the present preferred embodiment. Beams B001 to B005 shown in this FIG. 11 correspond respectively to the beams B001 to B005 shown in FIG. 6. If the number of beams of an independent multibeam is five, the direction detector 57 divides this multibeam into three lower-order classes (a) to (c), as shown in FIG. 11. The direction detector 57 selects three beams, which is a beam group, from among the beams B001 to B005 and allocate the beams to each lower-order class. Specifically, the direction detector 57 allocates the beams B001 to B003, among the beams B001 to B005, to the lower-order class (a). In addition, the direction detector 57 allocates the beams B002 to B004, among the beams B001 to B005, to the lower-order class (b). Yet additionally, the direction detector 57 allocates the beams B003 to B005, among the beams B001 to B005, to the lower-order class (c).

The respective beams B001 to B005 have directivities shown in FIG. 6. The lower-order class (a) to which the beams B001 to B003 are allocated has a directional sensitivity distribution obtained by summing the beams B001 to B003. Likewise, the lower-order class (b) has a directional sensitivity distribution obtained by summing the beams B002 to B004, and the lower-order class (c) has a directional sensitivity distribution obtained by summing the beams B003 to B005. These three lower-order classes have sensitivity distributions complementary to one another. In other words, another lower-order class has sensitivity in a direction in which a certain lower-order class does not have sensitivity.

In this specific example, the multibeams are allocated so that the beams B002 and B003 are shared and the beams B001 and B004 are not shared in the lower-order classes (a) and (b) adjacent to each other. In addition, the multibeams are allocated so that the beams B003 and B004 are shared and the beams B002 and B005 are not shared in the lower-order classes (b) and (c) adjacent to each other. That is, multibeams are allocated to each lower-order class, so that two multibeams are shared, among three multibeams, and one multibeam is not shared in lower-order classes adjacent to each other. As described above, all of the beams of respective beam groups are combined differently.

The direction detector 57 calculates eigenvalues for each lower-order class (steps S130 to S150). Specifically, the direction detector 57 estimates the number of incoming waves (the number of targets) for the lower-order classes (a) to (c). Known methods, such as AIC (Akaike Information Criteria) and MDL (Minimum Description Length) are used in this estimation of the number of incoming waves. Here, a case in which the direction detector 57 estimates that the number of incoming waves in the lower-order class (a) is three, the number of incoming waves in the lower-order class (b) is three, and the number of incoming waves in the lower-order class (c) is zero will be cited and described as an example.

The direction detector 57 selects compatibility conditions based on the number of incoming waves estimated for each lower-order class (step S160). Here, examples of compatibility conditions are shown in FIGS. 12 to 14.

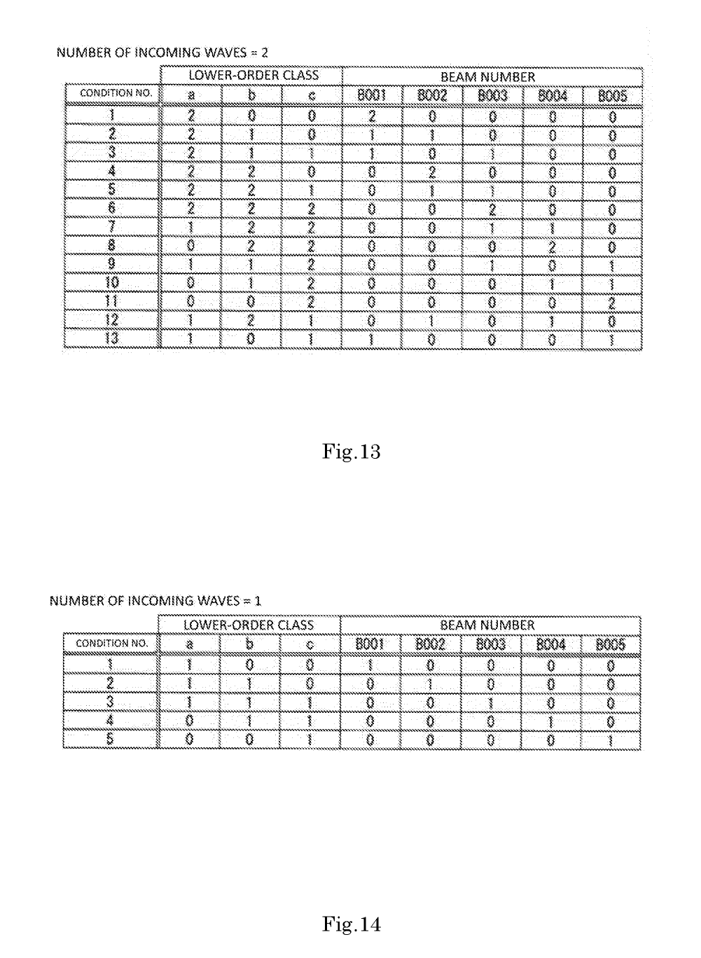

FIGS. 12 to 14 are tables showing examples of compatibility conditions in a case where the number of incoming waves in the present preferred embodiment is three to one. FIG. 12 is a table showing an example of compatibility conditions in a case where the number of incoming waves in the present preferred embodiment is three, whereas FIG. 13 is a table showing one example of compatibility conditions in a case where the number of incoming waves in the present preferred embodiment is two, and FIG. 14 is a table showing one example of compatibility conditions in a case where the number of incoming waves in the present preferred embodiment is one. These tables of compatibility conditions shown in FIGS. 12 to 14 are previously stored in an unillustrated storage unit. FIG. 12 will be cited as an example to describe compatibility conditions. Specifically, compatibility conditions in which the number of incoming waves in the lower-order class (a) is three, the number of incoming waves in the lower-order class (b) is three, and the number of incoming waves in the lower-order class (c) is zero are stored in this storage unit as Condition No. 1 of the compatibility conditions table shown in FIG. 12. The direction detector 57 searches out compatibility conditions, from among the compatibility conditions tables stored in this storage unit, whose number of incoming waves in each of the lower-order classes (a) to (c) is coincident, and selects the compatibility conditions obtained by the search (hit in the search). That is, the direction detector 57 selects Condition No. 1 shown in FIG. 12 as compatibility conditions in the above-described example.

Note that in the detection of the number of incoming waves in each lower-order class, specific thresholds are set with respect to the intensity of reflected signals detected with respective beams constituting a lower-order class, and a signal lower in intensity than a certain threshold is regarded as not being existent or as a signal from a different type of target to exclude the signal from determination. Alternatively, only the signals whose signal intensities are within a specific range are taken out to apply the tables of FIGS. 12 to 14 to the signals and select compatibility conditions.

The direction detector 57 estimates the range and eigenvalues of incoming waves based on the number of incoming waves for each beam number indicated by the selected compatibility conditions (step S170). Here, the number of incoming waves for each of the beam numbers indicated by Condition No. 1 given as compatibility conditions shown in FIG. 12 is zero for the beam B001, three for the beam B002, zero for the beam B003, zero for the beam B004, and zero for the beam B005. That is, in the above-described example, the direction detector 57 estimates the range and eigenvalues of incoming waves based on the number of incoming waves (zero for the beam B001, three for the beam B002, zero for the beam B003, zero for the beam B004, and zero for the beam B005) for each beam number indicated by Condition No. 1. More specifically, the direction detector 57 estimates that the range of incoming waves is the range of the beam B002 and the eigenvalue is three. Here, a compatibility conditions table is an example of a correlation matrix representing a correlation among a plurality of beams.

In this manner, the direction detector 57a can estimate an outline of directions in which targets exist. In order to know more precise directions, a maximum likelihood estimation method is combined with this estimation. Consider a case where incoming waves, one in the lower-order class (a), one in the lower-order class (b) and three in the lower-order class(c), are detected. From the compatibility conditions tables shown in FIG. 12, it is understood that Condition No. 14 is coincident in this case and that one wave arrives for the beam B003 and two waves arrive for the beam B005. Here, the target fixing unit 58 selects the lower-order class (b) including the beams B002 and B004, which are beams adjacent to the beam B003, as a reflected wave arrival direction estimation signal and executes a maximum likelihood estimation method. At that time, however, the target fixing unit 58 disapplies the threshold discussed earlier and performs processing on signals including reflected signals lower in intensity than the threshold. In this manner, the directions of targets can be estimated with a higher degree of accuracy.

As has been described heretofore, the direction detector 57 in the present preferred embodiment estimates multibeams, among five multibeams, in which incoming waves are included, based on compatible conditions tables. Consequently, the target fixing unit 58 in the present preferred embodiment can estimate reflected wave arrival directions and fix targets with independent multibeams less in number than five, without using all of the five independent multibeams. That is, the target fixing unit 58 can fix targets without performing computations on multibeams not contributing to target detection. Here, use of three independent multibeams enables a reduction in the amount of computation used to estimate reflected wave arrival directions, compared with a case where all of the five independent multibeams are used. Accordingly, the signal processor 8 in the present preferred embodiment can reduce a computational load applied to detect targets.

If the independent multi-beam radar apparatus 101 of the present preferred embodiment is a vehicle-mounted radar, the apparatus can reduce a computational load applied to detect targets by being provided with the above-described signal processor 8. The apparatus can therefore improve reaction rates in collision avoidance control, intrusion detection control, and obstacle detection control.

Although an example in which the number of independent multibeams is five and the number of multibeams to be selected is three has been described above, the present invention is not limited to this example. If the number of multibeams to be selected is less than the number of independent multibeams, it is possible to reduce a computational load applied to detect targets. For example, a computational load applied to detect targets can be reduced if the number of independent multibeams is four or greater in a case where the number of multibeams to be selected is three.

### Second Preferred Embodiment

Next, a second preferred embodiment of the present invention will be described.

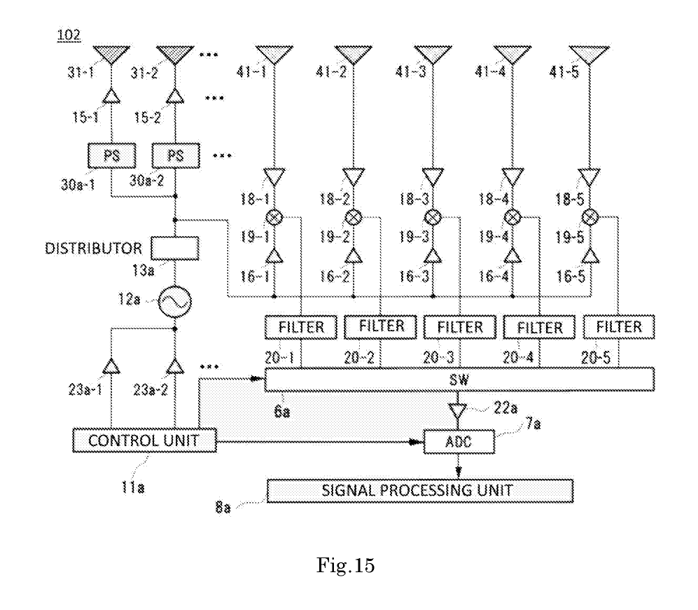

FIG. 15 is a block diagram illustrating the configuration of a phased-array antenna-type radar apparatus 102 according to a preferred embodiment of the present invention. Beams formed by transmitting antenna elements (transmitting elements) 31-1 and 31-2 overlap with each other. Note that although the apparatus includes five antenna elements constituting a transmitting antenna, only two of the elements are shown as representative elements. The output of a voltage-controlled oscillator (VCO) 12a is distributed by a distributor 13a and is fed to the transmitting antenna elements 31-1 and 31-2 through phase shifters 30a-1 and 30a-2 and amplifiers 15-1 and 15-2. The apparatus actually includes five phase shifters and amplifiers, though both are represented by the phase shifters 30a-1 and 30a-2 and the amplifiers 15-1 and 15-2 as in the case of the transmitting antenna elements 31-1 and 31-2.

Beams formed by receiving antennas 41-1 to 41-5 also overlap with one another. The number of antenna elements included in the apparatus to constitute the receiving antennas is also five. The receiving antennas 41-1 to 41-5 receive reflected waves (i.e., received waves) which arrive as the result of transmitted waves transmitted from the transmitting antennas 31-1 to 31-5 being reflected by physical objects, and output the received waves to the amplifiers 18-1 to 18-5. The amplifiers 18-1 to 18-5 amplify the received waves input from the receiving antennas 41-1 to 41-5, and output the received waves to the mixers 19-1 to 19-5. The output of the distributor 13a is input to the mixers 19-1 to 19-5 through the amplifiers 16-1 to 16-5 and mixed with signals received by the receiving antennas 41-1 to 41-5 to generate beat signals corresponding to respective frequency differences. The generated beat signals are output to filters 20-1 to 20-5.

A switch 6a is connected to the filters 20-1 to 20-5. In addition, an analog/digital converter 7a is connected to the switch 6a through an amplifier 22a. A signal processor 8a is connected to the analog/digital converter 7a. The operations of the filters 20-1 to 20-5, the switch 6a, the amplifier 22a, the analog/digital converter 7a, and the signal processor 8a are the same as in the first preferred embodiment, and therefore, will not be discussed here.

In the second preferred embodiment, the apparatus is provided with the phase shifters 30a-1 to 30a-5 and characterized by the way the phase shifters 30a-1 to 30a-5 are operated. The phase differences of high-frequency waves output to the transmitting antenna elements 31-1 and 31-2 are adjusted to form beams having limited directivity. This beam formation is performed by means of so-called beam forming. By changing the way variable phase differences are provided, it is possible to form beams having directivities in different directions. In this example, beams having directivities in five different directions are formed. This method uses simulation to realize multibeams in the first preferred embodiment by beam forming.

A method of carrying out various preferred embodiments of the present invention in the signal processor 8a when beams having directivities in five different directions are used is the same as in the first preferred embodiment, and therefore, will not be discussed here.

In the second preferred embodiment, phase differences between the directional distribution patterns of sensitivity are varied by the phase shifters 30a-1 to 30a-5, in order to estimate reflected wave arrival directions.

In the second preferred embodiment, beam forming is performed by varying the phases of radio waves output from the transmitting antenna elements 31-1 and 31-2 using the phase shifters 30a-1 to 30a-5 to form beams having limited directivity. Beam forming is not limited to the side of the transmitting antenna elements, however. Alternatively, digital beam forming can be performed on the received signals of the receiving antenna elements. In this case, the same effect as produced by beam-forming the high-frequency waves of the transmitting antenna elements can be obtained. Performing beam forming on either one of the transmitting antenna elements side and the receiving antenna elements side makes available the effect of limiting the directivity of the antenna. However, performing beam forming on both the transmitting antenna elements side and the receiving antenna elements side enables a further enhancement of directivity.

In the present preferred embodiment, an FMCW method has been cited as an example of a radar method to describe the present preferred embodiment. However, it is also possible to apply the same configuration as that of the present preferred embodiment to other radar methods, without being prepossessed by the above-mentioned radar method.

In addition, in the present preferred embodiment, a MUSIC method has been cited as an example of a high-resolution algorithm to describe the preferred embodiment. However, it is also possible to apply the same configuration as that of the present preferred embodiment to other methods, such as a linear predictive method and a beam forming method. For example, direction angles can be calculated using virtual array data and virtual array steering vectors. It is also possible to apply, for example, a maximum likelihood estimation method as a high-resolution algorithm.

As has been described heretofore, the independent multi-beam radar apparatus 101 according to the present preferred embodiment has such configurations as Apparatus Configurations 1 to 4 described below.

As Apparatus Configuration 1, the independent multi-beam radar apparatus 101 according to the present preferred embodiment detects (fixes) targets according to a method selected based on received data (beam element data y(m)) on the beam elements 2-1 to 2-M.

As Apparatus Configuration 2, the independent multi-beam radar apparatus 101 according to the present preferred embodiment selects a plurality of beams as lower-order class beams from among independent multibeams formed by the antenna section when performing processing according to Apparatus Configuration 1.

As Apparatus Configuration 3, the independent multi-beam radar apparatus 101 according to the present preferred embodiment estimates the number of targets based on a correlation matrix representing a correlation among the plurality of beams selected as lower-order class beams when performing processing according to Apparatus Configuration 1.

As Apparatus Configuration 4, the independent multi-beam radar apparatus 101 according to the present preferred embodiment estimates the number of targets based on the eigenvalues of the correlation matrix representing a correlation among the plurality of beams selected as lower-order class beams when performing processing according to Apparatus Configuration 1.

By having Apparatus Configurations 1 to 3, the independent multi-beam radar apparatus 101 according to the present preferred embodiment has the effect of being able to select a detection method having detection performance and detection time suited for use in target detection, according to distances to targets.

By having Apparatus Configurations 1 to 4, the independent multi-beam radar apparatus 101 according to the present preferred embodiment has the effect of being able to reduce a computational load applied to detect targets.

Although in the present preferred embodiment, a configuration has been shown in which the dielectric lens 1 is used, other various lenses or the like may be used in place of the dielectric lens 1.

In addition, although in the present preferred embodiment, a configuration has been shown in which the apparatus is provided with a lens (dielectric lens 1), a configuration not including a lens may be applied as another configurational example. In this case, independent multibeam-based transmission/reception is performed using the plurality of beam elements 2-1 to 2-M, without using a lens.

When detecting multiple targets, it is possible to detect as many targets as one target less (M-1) than the number (M) of the plurality of beam elements 2-1 to 2-M constituting an antenna used to perform transmission/reception.

Although applications with regard to five-element beams have been described above by way of example, an FOV (field of view), a beam width, the number of beam elements, and the like can be set optionally, according to the application and specifications of a radar. In an independent multibeam system based on a lens antenna in particular, these parameters can be set flexibly, depending on the shape of a lens and the position of a primary feed (beam element). This configuration is therefore suitable as a combination.

In the above-described preferred embodiments, configurations have been shown in which the radar apparatus 101 of an independent multibeam type illustrated in FIG. 1 is mounted on an automotive vehicle or the like as an automotive apparatus. As another preferred embodiment, however, the apparatus can also be mounted on other optional mobile objects.

Note that a program for realizing the functions of the control unit 11 and the signal processor 8 in FIG. 1 may be stored in a computer-readable storage medium, and make the program stored in this storage medium read into a computer system and executed therein to perform processing. The phrase “computer system” as referred to here includes an OS (Operating System) and hardware, such as peripheral devices. The “computer system” also includes a WWW system provided with a website providing environment (or a website displaying environment). In addition, the phrase “computer-readable storage medium ” refers to a portable medium, such as a flexible disk, a magnetooptic disk, a ROM (Read Only Memory) or a CD-ROM, or a storage device such as a hard disk built in the computer system.

In addition, the above-described program may be transferred from the computer system, where this program is stored in a storage device or the like, to another computer system through a transmission medium or by means of transmission waves in the transmission medium. Here, the phrase “transmission medium” which transfers the program refers to a medium, including a network (communications network), such as the Internet and a communications line, such as a telephone circuit, which has the function of transferring information. Yet additionally, the above-described program may be for the purpose of realizing part of the function mentioned above. Still additionally, the program may be one capable of realizing the abovementioned function in combination with a program already stored in the computer system, i.e., a so-called differential file (differential program).

While the respective preferred embodiments of the present invention have been described in detail with reference to the accompanying drawings, specific configurations are not limited to these preferred embodiments, but designs within a scope not departing from the subject matter of the present invention are also included in the present invention.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-12. (canceled)

13. A method of estimating a reflected wave arrival direction using a radar apparatus including an antenna capable of selecting and transmitting or receiving one of three or more directional distribution patterns of sensitivity, the method comprising:
obtaining a first reflected signal by performing one or both of transmitting and receiving of radio waves using a first pattern which is one of the three or more directional distribution patterns of sensitivity;
obtaining a number of first targets by estimating a number of targets in a reflected wave based on the first reflected signal;
obtaining a second reflected signal by performing one or both of the transmitting and receiving of radio waves using a second pattern which is one of the three or more directional distribution patterns of sensitivity;
obtaining a number of second targets by estimating the number of targets in the reflected wave based on the second reflected signal;
obtaining a third reflected signal by performing one or both of the transmitting and receiving of radio waves using a third pattern which is one of the three or more directional distribution patterns of sensitivity;
obtaining a number of third targets by estimating the number of targets in the reflected wave based on the third reflected signal; and
estimating a number of targets and a direction of presence of the targets using the number of the first targets, the number of the second targets, the number of the third targets, the first directional distribution pattern of sensitivity, the second directional distribution pattern of sensitivity, and the third directional distribution pattern of sensitivity.

14. The method of estimating a reflected wave arrival direction according to claim 13, further comprising:
selecting one directional distribution pattern of sensitivity in which the antenna has sensitivity to an estimated direction of presence of the targets from the three or more directional distribution patterns of sensitivity;
selecting the reflected signal obtained in the selected pattern as a reflected wave arrival direction estimation signal if the selected pattern is one of the first to third patterns;
obtaining a reflected wave arrival direction estimation signal by performing one or both of the transmitting and receiving of radio waves using the selected pattern if the selected pattern is none of the first to third patterns; and
making a calculation to estimate a reflected wave arrival direction using the estimated number of targets and the reflected wave arrival direction estimation signal for a direction in which the antenna has sensitivity in the selected pattern.

15. The method of estimating a reflected wave arrival direction according to claim 13, wherein the antenna has sensitivity in the second pattern in a portion of a direction in which the antenna does not have sensitivity in the first pattern, the antenna has sensitivity in the third pattern in a portion of a direction in which the antenna does not have sensitivity in the second pattern, and the antenna has sensitivity in the first pattern in a portion of a direction in which the antenna does not have sensitivity in the third pattern.

16. The method of estimating a reflected wave arrival direction according to claim 14, wherein the antenna has sensitivity in the second pattern in a portion of a direction in which the antenna does not have sensitivity in the first pattern, the antenna has sensitivity in the third pattern in a portion of a direction in which the antenna does not have sensitivity in the second pattern, and the antenna has sensitivity in the first pattern in a portion of a direction in which the antenna does not have sensitivity in the third pattern.

17. The method of estimating a reflected wave arrival direction according to claim 13, wherein the antenna includes three or more antenna elements, and two or more antenna elements of the three or more antenna elements but less than a total number of the antenna elements are driven in one or more of the first to third patterns.

18. The method of estimating a reflected wave arrival direction according to claim 16, wherein the antenna includes three or more antenna elements, and two or more antenna elements of the three or more antenna elements but less than ae total number of the antenna elements are driven in one or more of the first to third patterns.

19. The method of estimating a reflected wave arrival direction according to claim 13, wherein the antenna includes three or more antenna elements, two or more antenna elements of the three or more antenna elements but less than a total number of the antenna elements are driven in at least two patterns of the first to third patterns, and a combination of the antenna elements to be driven differs between the at least two patterns.

20. The method of estimating a reflected wave arrival direction according to claim 16, wherein the antenna includes three or more antenna elements, two or more antenna elements of the three or more antenna elements but less than a total number of the antenna elements are driven in at least two patterns of the first to third patterns, and a combination of the antenna elements to be driven differs between the at least two patterns.

21. The method of estimating a reflected wave arrival direction according to claim 13, wherein the antenna includes three or more antenna elements, two or more antenna elements of the three or more antenna elements but less than a total number of the antenna elements are driven in at least two patterns of the first to third patterns, each of the antenna elements to be driven in the at least two patterns includes a phase shifter that generates a phase difference between radio waves to be transmitted or received, the phase difference generated by the phase shifter is variable, and a value of the phase difference generated by the phase shifter differs between the at least two patterns.

22. The method of estimating a reflected wave arrival direction according to claim 16, wherein the antenna includes three or more antenna elements, two or more antenna elements of the three or more antenna elements but less than a total number of the antenna elements are driven in at least two patterns of the first to third patterns, each of the antenna elements to be driven in the at least two patterns includes a phase shifter that generates a phase difference between radio waves to be transmitted or received, the phase difference generated by the phase shifter is variable, and a value of the phase difference generated by the phase shifter differs between the at least two patterns.

23. The method of estimating a reflected wave arrival direction according to claim 13, wherein the antenna includes three or more antenna elements, and at least two of the three or more antenna elements have different sensitive directions.

24. The method of estimating a reflected wave arrival direction according to claim 16, wherein the antenna includes three or more antenna elements, and at least two of the three or more antenna elements have different sensitive directions.

25. The method of estimating a reflected wave arrival direction according to claim 17, wherein the antenna includes a dielectric lens.

26. The method of estimating a reflected wave arrival direction according to claim 13, wherein the antenna is a phased-array antenna including three or more antenna elements, at least two of the three or more antenna elements each include a phase shifter that generates a phase difference between radio waves to be transmitted, beam forming is performed in at least two patterns of the first to third patterns by generating a phase difference between radio waves using the phase shifters, and the at least two patterns have beam shapes extending from the antenna in directions different from each other.

27. The method of estimating a reflected wave arrival direction according to claim 16, wherein the antenna is a phased-array antenna including three or more antenna elements, at least two of the three or more antenna elements each include a phase shifter that generates a phase difference between radio waves to be transmitted, beam forming is performed in at least two patterns of the first to third patterns by generating a phase difference between radio waves using the phase shifters, and the at least two patterns have beam shapes extending from the antenna in directions different from each other.

28. The method of estimating a reflected wave arrival direction according to claim 26, wherein digital beam forming to extract components in a direction in which the beam extends in the patterns in which the respective reflected signals are obtained is performed on at least two reflected signals, among the first to third reflected signals, obtained by the transmitting and receiving in the at least two patterns.

29. The method of estimating a reflected wave arrival direction according to claim 27, wherein digital beam forming for extract components in a direction in which the beam extends in the patterns in which the respective reflected signals are obtained is performed on at least two reflected signals, among the first to third reflected signals, obtained by transmitting and receiving in the at least two patterns.

30. The method of estimating a reflected wave arrival direction according to claim 17, wherein two or more of the three or more antenna elements are driven in all of the first to third patterns and a correlation matrix and an eigenvalue of the correlation matrix are calculated for each of the first to third reflected signals when the numbers of the first to third targets are obtained.

31. The method of estimating a reflected wave arrival direction according to claim 26, wherein two or more of the three or more antenna elements are driven in all of the first to third patterns and a correlation matrix and an eigenvalue of the correlation matrix are calculated for each of the first to third reflected signals when the numbers of the first to third targets are obtained.

32. A non-transitory computer readable medium including a control program stored thereon that causes a computer to perform a method of executing estimation of a reflected wave arrival direction using a radar apparatus including an antenna capable of selecting and transmitting or receiving one of three or more directional distribution patterns of sensitivity, the method comprising:
obtaining a first reflected signal by performing one or both of transmitting and receiving of radio waves using a first pattern which is one of the three or more directional distribution patterns of sensitivity;
obtaining a number of first targets by estimating a number of targets in a reflected wave based on the first reflected signal;
obtaining a second reflected signal by performing one or both of the transmitting and receiving of radio waves using a second pattern which is one of the three or more directional distribution patterns of sensitivity;
obtaining a number of second targets by estimating the number of targets in the reflected wave based on the second reflected signal;
obtaining a third reflected signal by performing one or both of the transmitting and receiving of radio waves using a third pattern which is one of the three or more directional distribution patterns of sensitivity;
obtaining a number of third targets by estimating the number of targets in the reflected wave based on the third reflected signal; and
estimating a number of targets and a direction of presence of the targets using the number of the first targets, the number of the second targets, the number of the third targets, the first directional distribution pattern of sensitivity, the second directional distribution pattern of sensitivity, and the third directional distribution pattern of sensitivity.
